(19) United States
(12) Patent Application Publication
(10) Pub. No.: US 2021/0371580 A1
(43) Pub. Date: Dec. 2, 2021

(54) SINGLE-LAYER POLYESTER THIN FILM AND COATED METAL PLATE

(71) Applicant: BAOSHAN IRON & STEEL CO., LTD., Shanghai (CN)

(72) Inventors: Long XIE, Shanghai (CN); Hongxing CHEN, Shanghai (CN); Jingge DAI, Shanghai (CN)

(73) Assignee: BAOSHAN IRON & STEEL CO., LTD., Shanghai (CN)

(21) Appl. No.: 17/277,175

(22) PCT Filed: Sep. 18, 2019
(86) PCT No.: PCT/CN2019/106468

§ 371 Date: Mar. 17, 2021

(30) Foreign Application Priority Data
Sep. 19, 2018 (CN) 201811090612.9

(51) Int. Cl. C08G 63/183; C08G 63/199; C08J 5/18; B32B 15/09; B32B 15/18; B32B 37/06; B32B 37/10

(52) U.S. Cl. CPC C08G 63/183; C08G 63/199; C08J 5/18; B32B 15/09; C08K 3/36; B32B 37/06; B32B 37/10; C08J 2367/02; B32B 15/18

(57) ABSTRACT

Disclosed are a polyester thin film and a coated metal plate. The polyester thin film is a single-layer structure prepared from chips of a specific copolyester by means of a biaxial stretching method or a casting method, wherein the specific copolyester comprises SiO₂ in an amount of 800-2000 ppm by mass added by means of in situ polymerization, and the specific copolyester is a PET polyester resulting from copolymerization modification with isophthalic acid, 1,4-cyclohexanedimethanol and neopentyl glycol. The coated metal plate comprises a metal substrate and the polyester thin film. The polyester thin film has high food safety characteristics, along with many advantages such as excellent thermal adhesion with a metal plate, excellent deep-drawing processing and complex deformation processing properties, and excellent corrosion resistance, and can be widely used in the medium-to-high end metal packaging industry.

### TECHNICAL FIELD

The present disclosure relates to the field of film-laminated metal plates for metal packaging of food, and more particularly to a monolayer polyester film and a film-laminated metal plate.

### BACKGROUND ART

Coatings containing bisphenol A are widely used in the metal canmaking industry. In recent years, as the environmental protection, energy consumption and food safety issues have gradually attracted worldwide concern, the community of the industry has been committed to developing qualified new materials to address the above challenges.

Film-laminated steel is a new material obtained by directly bonding a flexible polyester film to a metal plate together by a hot melt lamination. This new material brings many advantages to downstream users: 1. it eliminates the step of applying a coating, and realizes the environmental friendliness of the process; 2. the food safety level is promoted significantly as compared with coated steel; 3. the overall performance is improved greatly as compared with coated steel; and 4. continuous forming and processing of cans/lids can be realized.

As environmental protection policies become more and more stringent and people's concern about food safety increases, the film-laminated steel has attracted more and more attention as a new environmentally friendly high-performance material in the canmaking industry due to the abovementioned various advantages of the film-laminated steel. In recent years, the film-laminated steel products of some companies have been marketed. In order to meet the differentiated needs of different uses, the design of the raw materials and film structure of the polyester film needs to be optimized to meet the different requirements of the downstream processes.

CN 102463725 A discloses a polyester film and a method of preparing the same. The polyester film of this patent application has a three-layer (ABA) structure, and is used in the field of electronic tags. The film structure is characterized by the same resin material for two skin layers. Hence, it is difficult to meet the various performance requirements such as bonding with a metal plate, contact with a mold for molding, contact with the contents of a container, etc., which easily leads to difficulties in balancing performances, not suitable for the canmaking industry.

CN 106142782 B discloses a polyester film for thermal lamination on steel and a method of preparing the same. This patent is characterized by lamination of a polyester film having a three-layer structure on a metal sheet. Because the performance of the film is limited by the high crystallinity of the lower skin layer, its processability and formability are not sufficient, and thus it is not suitable for uses involving deep drawing and complex deformation.

CN 1839036 discloses a film-laminated metal plate and a drawn can using the same. This patent uses a double-layer film for lamination on a thin metal plate. Defects such as delamination and spalling occur easily during the canmaking process. A vinyl ionomer is used as an intermediate bonding layer which has poor performance during filling and high temperature sterilization.

CN 102432984 A discloses a cast polyester film and a metal plate and a metal can using the same. This patent uses a monolayer polyester film for lamination on a metal sheet. The single modifying monomer in the polyester is not conducive to improving the overall performance of the polyester film. Moreover, the raw material synthesis and film preparation process in this patent are not conducive to promoting the food safety level of the film.

A film-laminated metal plate needs to have sufficient guarantee of food safety. At the same time, it also needs to meet the requirements of deep drawing, resistance to acids, bases and salts to be canned, high temperature sterilization, etc. In the prior art, only one or two of the above performance requirements can be met. However, as the high-end requirements of the food or beverage packaging industry, the above three requirements must be met at the same time.

### SUMMARY

An object of the present disclosure is to provide a monolayer polyester film and a film-laminated metal plate using the monolayer polyester film. The film-laminated metal plate has an attribute of high-level food safety, excellent endurance in deep drawing processing and complex deformation processing, excellent corrosion resistance and many other advantages. It can be widely used in the container industry for medium-end to high-end food or beverage packaging.

In order to achieve the above object, the following technical solution is adopted according to the present disclosure.

According to one aspect of the present disclosure, there is provided a copolyester, wherein the copolyester is a PET polyester modified by copolymerization of isophthalic acid, 1,4-cyclohexanedimethanol and neopentyl glycol, and comprises 800-2000 ppm by mass of SiO₂. Preferably, the SiO₂ is added by in-situ polymerization.

The copolyester according to one aspect of the present disclosure has a melting point of 200-240° C., preferably 210-230° C.

The copolyester according to one aspect of the present disclosure has an intrinsic viscosity of 0.68-0.72 dL/g.

The copolyester according to one aspect of the present disclosure has an intrinsic viscosity of 0.75-0.78 dL/g after solid phase tackification.

According to one aspect of the present disclosure, there is provided a polyester film comprising the copolyester described in any of the embodiments herein. Preferably, the polyester film comprises the copolyester described in any of the embodiments herein in a monolayer structure. Preferably, the monolayer structure is prepared by a biaxial stretching process or a casting process.

The polyester film according to one aspect of the present disclosure is a monolayer structure prepared from a specific copolyester chip by a biaxial stretching process or a casting process, wherein the specific copolyester comprises 1200 ppm by mass of SiO₂ added by in-situ polymerization, and the specific copolyester is a PET polyester modified by copolymerization of isophthalic acid, 1,4-cyclohexanedimethanol and neopentyl glycol.

In the polyester film according to one aspect of the present disclosure, the specific copolyester has a melting point of 200-240° C.

Preferably, the specific copolyester has a melting point of 210-230° C.

In the polyester film according to one aspect of the present disclosure, the specific copolyester has an intrinsic viscosity of 0.68-0.72 dL/g, and an intrinsic viscosity of 0.75-0.78 dL/g after solid phase tackification.

According to another aspect of the present disclosure, there is provided a film-laminated metal plate, wherein the film-laminated metal plate comprises a metal substrate and the polyester film described in any of the embodiments herein.

In the film-laminated metal plate according to another aspect of the present disclosure, the polyester film is directly laminated on a surface of the metal substrate by hot melt lamination.

In the film-laminated metal plate according to another aspect of the present disclosure, the metal substrate is selected from the group consisting of a chromium-plated steel plate, a tin-plated steel plate, a low-tin steel plate, a galvanized steel plate, a cold-rolled steel plate, a stainless steel plate, and an aluminum plate.

According to still another aspect of the present disclosure, there is provided a metal container for medium-end to high-end food or beverage packaging, wherein the metal container is made of the film-laminated metal plate described in any of the embodiments herein.

Compared with the prior art, the present disclosure has the following beneficial technical effects: the polyester film and the film-laminated metal plate according to the present disclosure have the following three characteristics at the same time: the polyester film has an attribute of high-level food safety, endurance in deep drawing processing and complex deformation processing, and excellent corrosion resistance, widely useful in the medium-end to high-end metal packaging industry.

Due to the addition of SiO₂ to the polymer in the in-situ polymerization, the crystallization properties of the polyester film are improved uniformly on the whole. By substituting the traditional way of adding SiO₂ in the form of master batch, addition of a high melting point resin to the film is avoided. The above two points have improved the overall performance of the polyester film significantly, and the complex processing endurance and corrosion resistance of the film-laminated steel comprising the film of the present disclosure have been improved notably.

### DETAILED DESCRIPTION

There is provided a copolyester, wherein the copolyester is a PET polyester modified by copolymerization of isophthalic acid, 1,4-cyclohexanedimethanol and neopentyl glycol, and comprises 800-2000 ppm by mass of SiO₂. Preferably, the SiO₂ is added by in-situ polymerization. Preferably, SiO₂ in the copolyester has a content of 1000-1500 ppm by mass, preferably 1200 ppm by mass. The term “added by in-situ polymerization” or the like as used herein refers to mixing SiO₂ with the monomers for synthesizing the copolyester (i.e., terephthalic acid, ethylene glycol, isophthalic acid, 1,4-cyclohexanedimethanol and neopentyl glycol), and then polymerizing to produce the copolyester according to the present disclosure. A conventional process for preparing PET polyester may be used to prepare the copolyester of the present disclosure. Preferably, the copolyester of the present disclosure has a melting point of 200-240° C., preferably 210-230° C. Preferably, the copolyester of the present disclosure has an intrinsic viscosity of 0.68-0.72 dL/g. Preferably, the copolyester of the present disclosure has an intrinsic viscosity of 0.75-0.78 dL/g after solid phase tackification.

In the present disclosure, the intrinsic viscosity is measured using a technique commonly used in the art.

The copolyester of the present disclosure can be used to manufacture a polyester film. In one embodiment of the present disclosure, the polyester film of the present disclosure has a monolayer structure comprising the copolyester described in any of the embodiments herein. In a particularly preferred embodiment, the copolyester comprises 1200 ppm by mass of SiO₂. Preferably, the polyester film of the present disclosure is prepared from a chip of the copolyester by a biaxial stretching process or a casting process.

There is further provided a film-laminated metal plate according to the present disclosure, wherein the film-laminated metal plate comprises a metal substrate and the polyester film described in any of the embodiments herein. In a preferred embodiment, the polyester film is directly laminated on a surface of the metal substrate by hot melt lamination. The metal substrate of the present disclosure is selected from the group consisting of a chromium-plated steel plate, a tin-plated steel plate, a low-tin steel plate (a tin coating weight of <1.1 g/m²), a galvanized steel plate, a cold-rolled steel plate, a stainless steel plate and an aluminum plate.

There is still further provided a metal container for medium-end to high-end food or beverage packaging according to the present disclosure, wherein the metal container is made of the film-laminated metal plate described in any of the embodiments herein.

In the following detailed description, the objectives, features, and advantages of the present disclosure will become clearer and more apparent with reference to the non-limiting examples. The content is sufficient to enable those skilled in the art to appreciate and implement the present disclosure.

### EXAMPLE 1

In the method of producing a film-laminated steel using a monolayer polyester film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 1200 ppm SiO₂ and having an intrinsic viscosity of 0.72 dL/g, and then obtain the specific copolyester having an intrinsic viscosity of 0.78 dL/g by solid phase tackyfication and a melting point of 220° C.

The specific copolyester chip was used to prepare a monolayer polyester film by a biaxial stretching process at a manufacturing temperature of 260-270° C.

Preparation of a film-laminated metal plate: the biaxially stretched polyester film thus prepared was thermally bonded to a surface of a thin metal plate having a thickness of 0.10-0.50 mm at a pressure of 2-10 kg and a temperature of 180-260° C. to obtain a film-laminated metal plate.

This Example provided a polyester film which was a monolayer structure prepared from a specific copolyester chip by a biaxial stretching process, wherein the specific copolyester comprised 1200 ppm by mass of SiO₂ added by in-situ polymerization, and the specific copolyester was a PET polyester modified by copolymerization of isophthalic acid, 1,4-cyclohexanedimethanol and neopentyl glycol.

The melting point of the specific copolyester was 220° C.

The intrinsic viscosity of the specific copolyester was 0.78 dL/g.

### EXAMPLE 2

In the method of producing a monolayer copolyester steel-laminating film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 1200 ppm SiO₂ and having an intrinsic viscosity of 0.68 dL/g, and then obtain the specific copolyester having an intrinsic viscosity of 0.75 dL/g by solid phase tackyfication and a melting point of 200° C.

The specific copolyester chip was used to prepare a monolayer polyester film by a biaxial stretching process at a manufacturing temperature of 250-270° C.

Preparation of a film-laminated metal plate: the biaxially stretched polyester film thus prepared was thermally bonded to a surface of a thin metal plate having a thickness of 0.10-0.50 mm at a pressure of 2-10 kg and a temperature of 180-260° C. to obtain a film-laminated metal plate.

This Example provided a polyester film which was a monolayer structure prepared from a specific copolyester chip by a biaxial stretching process, wherein the specific copolyester comprised 1200 ppm by mass of SiO₂ added by in-situ polymerization, and the specific copolyester was a PET polyester modified by copolymerization of isophthalic acid, 1,4-cyclohexanedimethanol and neopentyl glycol.

The melting point of the specific copolyester was 200° C.

The intrinsic viscosity of the specific copolyester was 0.75 dL/g.

### EXAMPLE 3

In the method of producing a monolayer copolyester steel-laminating film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 1200 ppm SiO₂ and having an intrinsic viscosity of 0.72 dL/g, and then obtain the specific copolyester having an intrinsic viscosity of 0.78 dL/g by solid phase tackyfication and a melting point of 230° C.

The specific copolyester chip was used to prepare a monolayer polyester film by a biaxial stretching process at a manufacturing temperature of 260-280° C.

The method of preparing the film-laminated steel is the same as Example 1.

This Example provided a polyester film which was a monolayer structure prepared from a specific copolyester chip by a biaxial stretching process, wherein the specific copolyester comprised 1200 ppm by mass of SiO₂ added by in-situ polymerization, and the specific copolyester was a PET polyester modified by copolymerization of isophthalic acid, 1,4-cyclohexanedimethanol and neopentyl glycol.

The melting point of the specific copolyester was 230° C.

The intrinsic viscosity of the specific copolyester was 0.78 dL/g.

### EXAMPLE 4

In the method of producing a monolayer copolyester steel-laminating film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 1200 ppm SiO₂ and having an intrinsic viscosity of 0.72 dL/g, and then obtain the specific copolyester having an intrinsic viscosity of 0.78 dL/g by solid phase tackyfication and a melting point of 230° C.

The specific copolyester chip was used to prepare a monolayer polyester film by a casting process at a manufacturing temperature of 260-280° C.

The method of preparing the film-laminated steel is the same as Example 1.

This Example provided a polyester film which was a monolayer structure prepared from a specific copolyester chip by a casting process, wherein the specific copolyester comprised 1200 ppm by mass of SiO₂ added by in-situ polymerization, and the specific copolyester was a PET polyester modified by copolymerization of isophthalic acid, 1,4-cyclohexanedimethanol and neopentyl glycol.

The melting point of the specific copolyester was 230° C.

The intrinsic viscosity of the specific copolyester was 0.78 dL/g.

### EXAMPLE 5

In the method of producing a monolayer copolyester steel-laminating film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 1200 ppm SiO₂ and having an intrinsic viscosity of 0.68 dL/g, and then obtain the specific copolyester having an intrinsic viscosity of 0.75 dL/g by solid phase tackyfication and a melting point of 200° C.

The specific copolyester chip was used to prepare a monolayer polyester film by a casting process at a manufacturing temperature of 250-270° C.

The method of preparing the film-laminated steel is the same as Example 1.

This Example provided a polyester film which was a monolayer structure prepared from a specific copolyester chip by a casting process, wherein the specific copolyester comprised 1200 ppm by mass of SiO₂ added by in-situ polymerization, and the specific copolyester was a PET polyester modified by copolymerization of isophthalic acid, 1,4-cyclohexanedimethanol and neopentyl glycol.

The melting point of the specific copolyester was 200° C.

The intrinsic viscosity of the specific copolyester was 0.75 dL/g.

### EXAMPLE 6

In the method of producing a monolayer copolyester steel-laminating film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 1200 ppm SiO₂ and having an intrinsic viscosity of 0.72 dL/g, and then obtain the specific copolyester having an intrinsic viscosity of 0.78 dL/g by solid phase tackyfication and a melting point of 240° C.

The method of preparing the film-laminated steel is the same as Example 1.

The specific copolyester chip was used to prepare a monolayer polyester film by a casting process at a manufacturing temperature of 260-270° C.

The method of preparing the film-laminated steel is the same as Example 1.

This Example provided a polyester film which was a monolayer structure prepared from a specific copolyester chip by a casting process, wherein the specific copolyester comprised 1200 ppm by mass of SiO₂ added by in-situ polymerization, and the specific copolyester was a PET polyester modified by copolymerization of isophthalic acid, 1,4-cyclohexanedimethanol and neopentyl glycol.

The melting point of the specific copolyester was 240° C.

The intrinsic viscosity of the specific copolyester was 0.78 dL/g.

### EXAMPLE 7

In the method of producing a monolayer copolyester steel-laminating film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 800 ppm SiO₂ and having an intrinsic viscosity of 0.70 dL/g, and then obtain the specific copolyester having an intrinsic viscosity of 0.76 dL/g by solid phase tackyfication and a melting point of 230° C.

The specific copolyester chip was used to prepare a monolayer polyester film by a casting process at a manufacturing temperature of 260-270° C.

The method of preparing the film-laminated steel is the same as Example 1.

### EXAMPLE 8

In the method of producing a monolayer copolyester steel-laminating film, the polyester film was prepared by using a specific copolyester chip.

The specific copolyester chip: isophthalic acid, 1,4-cyclohexanedimethanol and neopentyl glycol were introduced into a system comprising terephthalic acid and ethylene glycol as the main raw materials to carry out copolymerization. In the copolymerization, SiO₂ was added by in-situ polymerization to obtain a copolyester resin comprising 2000 ppm SiO₂ and having an intrinsic viscosity of 0.72 dL/g, and then obtain the specific copolyester having an intrinsic viscosity of 0.76 dL/g by solid phase tackyfication and a melting point of 220° C.

The specific copolyester chip was used to prepare a monolayer polyester film by a casting process at a manufacturing temperature of 260-270° C.

The method of preparing the film-laminated steel is the same as Example 1.

### COMPARATIVE EXAMPLE 1

A PET resin modified by IPA and having a melting point of 210° C. and a viscosity of 0.65 dL/g was made into a monolayer polyester film by a casting process. A silicon-containing chip comprising 30000 ppm SiO₂ was added to one side of the film, so that one side of the monolayer polyester film comprised 1800 ppm SiO₂ to achieve the effect of an anti-blocking agent.

Preparation of film-laminated steel: the polyester film prepared by the casting process was thermally bonded to the surface of a 0.19 mm chromium-plated steel plate at a pressure of 2-10 kg and a temperature of 180-260° C. to obtain the film-laminated steel.

### COMPARATIVE EXAMPLE 2

In a three-layer composite film, the upper layer resin was a 3 μm PET resin, the intermediate layer was a 14 μm blended resin of 265° C. PET and 210° C. PET (having a blending ratio of 7:3), and the lower layer was a 3 μm modified PET resin having a melting point of 210° C.

Preparation of film-laminated steel: the prepared biaxial stretched polyester film was thermally bonded to the surface of a 0.19 mm chromium-plated steel plate at a pressure of 2-10 kg and a temperature of 180-260° C. to obtain the film-laminated steel, wherein the lower layer was thermally laminated on the steel plate.

### COMPARATIVE EXAMPLE 3

In a three-layer composite film having an ABA structure, the upper layer resin was a modified PET resin having a melting point of 210° C., the intermediate layer was a PET resin having a melting point of 265° C., and the lower layer was a modified PET resin having a melting point of 210° C. The thickness ratio of the three layers was 1:8:1.

Preparation of film-laminated steel: the polyester film prepared by the biaxial stretching process was thermally bonded to the surface of a 0.19 mm chromium-plated steel plate at a pressure of 2-10 kg and a temperature of 180-260° C. to obtain the film-laminated steel.

### COMPARATIVE EXAMPLE 4

A two-layer composite film was prepared using a vinyl ionomer as an intermediate bonding layer.

Preparation of film-laminated steel: the polyester film prepared by the biaxial stretching process was thermally bonded to the surface of a 0.19 mm chromium-plated steel plate at a pressure of 2-10 kg and a temperature of 180-260° C. to obtain the film-laminated steel.

### Test Example

The film-laminated metal plates obtained in Examples 1-8 and Comparative Examples 1-4 were processed using the Draw and Redraw process (DRD) under the following processing conditions. They were formed into can bodies by punching three times. The 20 μm functional film prepared was located on both the inner and outer sides of the cans at the same time.

Processing Conditions (Draw and Redraw Process)

1.Blank diameter: 172 mm.

2.First-pass processing conditions

Punch diameter: 114.5 mm;

Die clearance: 0.36 mm;

Blank holder force: 4000 kg;

Mold assembly temperature before molding: 55° C.

3.Second-pass processing conditions

Punch diameter: 88 mm;

Die clearance: 0.4 mm;

Blank holder force: 3000 kg;

Mold assembly temperature before molding: 55° C.

4.Third-pass processing conditions

Punch diameter: 65.3 mm;

Die clearance: 0.43 mm;

Blank holder force: 2000 kg;

Mold assembly temperature before molding: 55° C.

After molding, conventional processes in can making were used for necking and flanging.

The cans prepared by the above methods were evaluated by the methods described below. The results are shown in Tables 1 and 2.

(1) Endurance in deep drawing canmaking

The resin film layer laminated on the steel plate surface was visually evaluated to see whether it was peeled off or not during the processing steps of the DRD can prepared under the abovementioned forming and processing conditions. The result where no peeling occurred till the final step is excellent.

(2) Acid resistance performance: After the film-laminated steel was punched into a can (can size 691), acid resistance performance evaluation was performed to represent corrosion resistance performance evaluation. The film-laminated can was filled with a 20 g/L citric acid solution. After the can was capped, the solution was boiled at 121° C. for 60 min. After cooling, the sample was taken out, and spots corroded by the acid on the surface of the sample were observed to evaluate the acid resistance performance of the film-laminated steel.

(3) Sulfur resistance performance: After the film-laminated steel was punched into a can (can size 691), sulfur resistance performance evaluation was performed to represent corrosion resistance performance evaluation. The film-laminated can was filled with a 1% Na₂S solution. After the can was capped, the solution was boiled at 121° C. for 60 min. After cooling, the sample was taken out, and sulfide spots on the surface of the sample were observed to evaluate the sulfur resistance performance of the film-laminated steel.

(1) Food safety: According to European Union Regulation EU No. 10/2011, with reference to EN 1186: Part 2, Part 3, Part 14, the total migration amounts of the film-laminated steel products were measured. A 10 cm*10 cm film-laminated steel plate sample was taken for measurement of the total migration amount in a relevant simulation solution. The food safety was evaluated based on the test result of the total migration amount of each film-laminated steel plate sample. The less the total migration amount, the higher the food safety.

TABLE 1
Evaluation results of food safety

Test Conditions

| | 3% acetic acid | 95 ethanol | Isooctane |
|---|---|---|---|
| | 100° C., | 60° C., | 60° C., |
| Test Item | 2 hours | 3.5 hours | 1.5 hours |
| Example 1 | Excellent | Excellent | Excellent |
| Example 2 | Excellent | Excellent | Excellent |
| Example 3 | Excellent | Excellent | Excellent |
| Example 4 | Excellent | Excellent | Excellent |
| Example 5 | Excellent | Excellent | Excellent |
| Example 6 | Excellent | Excellent | Excellent |
| Example 7 | Excellent | Excellent | Excellent |
| Example 8 | Excellent | Excellent | Excellent |
| Comparative | Good | Good | Good |
| Example 1 | | | |
| Comparative | Good | Good | Good |
| Example 2 | | | |
| Comparative | Good | Good | Good |
| Example 3 | | | |
| Comparative | Poor | Poor | Poor |
| Example 4 | | | |

TABLE 2
Evaluation results of deep drawing
endurance and corrosion resistance

| | Deep Drawing | Acid | Sulfur |
|---|---|---|---|
| Test Item | Endurance | Resistance | Resistance |
| Example 1 | ⊚ | ⊚ | ⊚ |
| Example 2 | ⊚ | ⊚ | ⊚ |
| Example 3 | ⊚ | ⊚ | ⊚ |
| Example 4 | ⊚ | ⊚ | ⊚ |
| Example 5 | ⊚ | ⊚ | ⊚ |
| Example 6 | ⊚ | ⊚ | ⊚ |
| Example 7 | ⊚ | ⊚ | ∘ |
| Example 8 | ⊚ | ⊚ | ⊚ |
| Comparative | X | − | − |
| Example 1 | | | |
| Comparative | X | − | − |
| Example 2 | | | |
| Comparative | − | − | − |
| Example 3 | | | |
| Comparative | ∘ | ∘ | Δ |
| Example 4 | | | |

Note:
in Table 1, X means poor; Δ means mediocre; ∘ means good; ⊚ means very good; − means unable to be evaluated.

In the above eight Examples, the monolayer polyester films prepared from the specific copolyester chips all exhibit good formability in both the casting process and the biaxial stretching process for making films, and the polyester steel-laminating films having a small thickness can be prepared. The polyester films have many advantages, such as high food safety, excellent endurance in deep drawing processing and complex deformation processing, and excellent corrosion resistance, widely useful in the medium-end to high-end metal packaging industry.

Due to the addition of SiO₂ to the polymer in the in-situ polymerization, the crystallization properties of the polyester film are improved uniformly on the whole. By substituting the traditional way of adding SiO₂ in the form of master batch, addition of a high melting point resin to the film is avoided. The above two points have improved the overall performance of the polyester film significantly, and the complex processing endurance and corrosion resistance of the film-laminated steel comprising the film of the present disclosure have been improved notably.

Finally, it should be pointed out that although the present disclosure has been described with reference to the specific examples, those skilled in the art should appreciate that the above examples are only used to illustrate the present disclosure, and are not used to limit the present disclosure. Various equivalent changes or substitutions can be made without departing from the concept of the present disclosure. Therefore, without departing from the essential spirit of the present disclosure, all changes and variations of the abovementioned examples will fall in the scope of the claims in the present disclosure.

1. A copolyester, wherein the copolyester is a PET polyester modified by copolymerization of isophthalic acid, 1,4-cyclohexanedimethanol and neopentyl glycol, and comprises 800-2000 ppm by mass of SiO₂.

2. The copolyester according to claim 1, wherein the copolyester has a melting point of 200-240° C.

3. The copolyester according to claim 2, wherein the copolyester has a melting point of 210-230° C.

4. The copolyester according to claim 1, wherein the copolyester has an intrinsic viscosity of 0.68-0.72 dL/g, and/or an intrinsic viscosity of 0.75-0.78 dL/g after solid phase tackification.

5. A polyester film, wherein the polyester film comprises the copolyester according to claim 1.

6. The polyester film according to claim 5, wherein the polyester film is a monolayer structure prepared from a specific copolyester chip, wherein the specific copolyester comprises 1200 ppm by mass of SiO₂ added by in-situ polymerization,
wherein the specific copolyester is a PET polyester modified by copolymerization of isophthalic acid, 1,4-cyclohexanedimethanol and neopentyl glycol.

7. The polyester film according to claim 6, wherein the specific copolyester has a melting point of 200-240° C.

8. The polyester film according to claim 7, wherein the specific copolyester has a melting point of 210-230° C.

9. The polyester film according to claim 6, wherein the specific copolyester has an intrinsic viscosity of 0.68-0.72 dL/g, and/or an intrinsic viscosity of 0.75-0.78 dL/g after solid phase tackification.

10. A method of preparing the polyester film according to claim 5, wherein the method comprises preparing the polyester film from the copolyester by a biaxial stretching process or a casting process, wherein the polyester film is prepared at a temperature of 250-280° C.

11. A film-laminated metal plate, wherein the film-laminated metal plate comprises a metal substrate and the polyester film according to claim 5.

12. The film-laminated metal plate according to claim 11, wherein the metal substrate is selected from the group consisting of a chromium-plated steel plate, a tin-plated steel plate, a low-tin steel plate, a galvanized steel plate, a cold-rolled steel plate, a stainless steel plate, and an aluminum plate; or the metal substrate has a thickness of 0.10-0.50 mm.

13. (canceled).

14. A method of manufacturing the film-laminated metal plate according to claim 11, wherein the method comprises direct thermal lamination of the polyester film on a surface of the metal substrate by hot melt lamination at a pressure of 2-10 kg and a temperature of 180-260° C.

15. A metal container for medium-end to high-end food or beverage packaging, wherein the metal container is made of the film-laminated metal plate of claim 11.

16. The film-laminated metal plate according to claim 11, wherein the polyester film is a monolayer structure prepared from a specific copolyester chip, wherein the specific copolyester comprises 1200 ppm by mass of SiO₂ added by in-situ polymerization, wherein the specific copolyester is a PET polyester modified by copolymerization of isophthalic acid, 1,4-cyclohexanedimethanol and neopentyl glycol.

17. The film-laminated metal plate according to claim 16, wherein the specific copolyester has a melting point of 200-240° C.

18. The film-laminated metal plate according to claim 16, wherein the specific copolyester has a melting point of 210-230° C.

19. The film-laminated metal plate according to claim 16, wherein the specific copolyester has an intrinsic viscosity of 0.68-0.72 dL/g, and/or an intrinsic viscosity of 0.75-0.78 dL/g after solid phase tackification.

20. The metal container for medium-end to high-end food or beverage packaging according to claim 15, wherein the metal substrate of the film-laminated metal plate is selected from the group consisting of a chromium-plated steel plate, a tin-plated steel plate, a low-tin steel plate, a galvanized steel plate, a cold-rolled steel plate, a stainless steel plate, and an aluminum plate; or the metal substrate of the film-laminated metal plate has a thickness of 0.10-0.50 mm.

21. The metal container for medium-end to high-end food or beverage packaging according to claim 15, wherein the polyester film of the film-laminated metal plate is a monolayer structure prepared from a specific copolyester chip, wherein the specific copolyester comprises 1200 ppm by mass of SiO₂ added by in-situ polymerization;
wherein the specific copolyester is a PET polyester modified by copolymerization of isophthalic acid, 1,4-cyclohexanedimethanol and neopentyl glycol; or wherein the specific copolyester has a melting point of 200-240° C., and/or has an intrinsic viscosity of 0.68-0.72 dL/g, and/or an intrinsic viscosity of 0.75-0.78 dL/g after solid phase tackification.
